(19) United States
(12) Patent Application Publication
(10) Pub. No.: US 2007/0079229 A1
(43) Pub. Date: Apr. 5, 2007

(54) Method and system for automatically determining the server-side technology underlying a dynamic web site

(76) Inventor: Peter Christopher Johnson II, Riverside, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/243,799

(22) Filed: Oct. 4, 2005

(51) Int. Cl. G06F 15/00

(52) U.S. Cl. 715/501.1

(57) ABSTRACT

An automated tool for determining the server-side technology underlying a dynamic Web site acquires one or more root Internet addresses, identifies hyperlinks within a specified link depth of each root internet address, extracts a file extension from a file name associated with each identified hyperlink, designates one or more dominant file extensions based on an analysis of occurrence data, and maps at least one dominant file extension to its corresponding server-side technology. The automated tool may, among other purposes, be used to generate sales leads or to develop a suitable migration path for a dynamic Web site.

### FIELD OF THE INVENTION

The present invention relates generally to dynamic Web sites on the Internet and more specifically to techniques for determining the technology underlying a dynamic Web site.

### BACKGROUND OF THE INVENTION

Many Web sites on the Internet include dynamic content. A dynamic Web site is one that generates Web pages, at least in part, through the execution of server-side code (e.g., a script). In some applications, the script may work in conjunction with a backend database server. Dynamic pages do not exist on the server, as static HTML pages do, until a request is received for the page.

A wide variety of technologies are used to create dynamic Web sites, including Microsoft Active Server Pages (ASP), Sun Java Server Pages (JSP), Struts, PHP (“Hypertext Preprocessor”), and Perl. ASP is a server-side scripting language based on VBScript, a variant of Visual Basic. A newer version of ASP is called ASP.NET. JSP is a server-side scripting language that, to some degree, competes with ASP. It allows the dynamic part of a Web page to be separated from the static HTML part. Struts is an application development framework that works in conjunction with JSP. PHP is also a server-side scripting language. Finally, Perl is an older interpretive scripting language for writing Common Gateway Interface (CGI) scripts. It combines the syntax of C, C++, sed, awk, grep, sh, and csh.

Since dynamic Web sites employ server-side technology and may be quite complex in structure, it may not be obvious to someone accessing a particular dynamic Web site which of the many server-side technologies is the dominant one used to generate dynamic pages on that site. Such information has potentially valuable business uses. For example, such information is important to those in the business of marketing server-side scripting technology. It is thus apparent that there is a need in the art for a method and system for automatically determining the server-side technology underlying a dynamic Web site.

### BRIEF DESCRIPTION OF THE DRAWINGS

FIG. 1 is a high-level block diagram of an environment in which the invention may operate, in accordance with an illustrative embodiment of the invention.

FIG. 2 is a conceptual diagram in accordance with an illustrative embodiment of the invention.

FIG. 3 is a flowchart of a method for automatically determining the server-side technology underlying a dynamic Web site in accordance with an illustrative embodiment of the invention.

FIG. 4 is a flowchart of a method for collecting and analyzing occurrence data associated with extracted file extensions in accordance with an illustrative embodiment of the invention.

FIG. 5 is an illustration of a system for automatically determining the server-side technology underlying a dynamic Web site in accordance with an illustrative embodiment of the invention.

FIG. 6 is an illustration of a computer-readable storage medium containing program code for automatically determining the server-side technology underlying a dynamic Web site in accordance with an illustrative embodiment of the invention.

### DETAILED DESCRIPTION OF THE INVENTION

One business use for information about the server-side technology underlying a dynamic Web site is to determine an advantageous technology migration path for the dynamic Web site. For example, a dynamic Web site using predominantly Microsoft Active Server Pages (ASP) might logically migrate to the newer ASP.NET. Another business use for such information is to determine whether an entity (e.g., a corporation or an individual) associated with a dynamic Web site is a potential customer for particular server-side technologies. For example, a seller of server-side technology may desire to probe a set of dynamic Web sites to determine whether they are using server-side technologies that would make the seller's products attractive. In this way, sales leads (potential customers) can be identified. As those skilled in the art will recognize, there are other potential business uses for information concerning the server-side technology underlying a dynamic Web site. The foregoing are merely a couple of examples.

Such information about the server-side technology underlying dynamic Web sites can be collected and analyzed through the use of an automated tool. The automated tool may, for each of M root Internet addresses (e.g., base URLs pointing to home pages), identify hyperlinks within a specified link depth N of the root Internet address, extract a file extension from a file name associated with each hyperlink, collect and analyze occurrence data for the various extracted file extensions to determine the dominant file extension or extensions at the particular site, and map one or more of the dominant file extensions to corresponding server-side technologies (e.g., using a lookup table). The occurrence data and mapping of dominant file extensions to server-side technologies may be reported to a user and may be used to accomplish business purposes such as those described above.

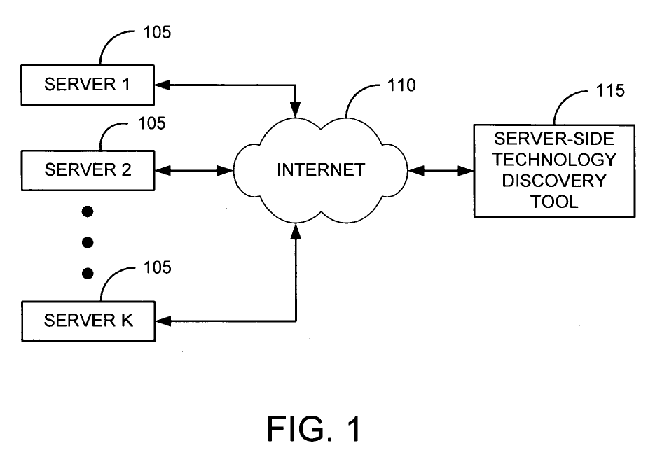

FIG. 1 is a high-level block diagram of an environment in which the invention may operate, in accordance with an illustrative embodiment of the invention. In FIG. 1, K servers 105 hosting dynamic Web sites are connected with the Internet 110. Each server 105 may host one or more dynamic Web sites. Also connected to the Internet 110 is a server-side technology discovery tool (“automated tool”) 115. Automated tool 115 may be implemented in a variety of ways. For example, it may be implemented in hardware, firmware, software, or any combination thereof. In one embodiment, automated tool 115 is a software application executed by a general-purpose computer connected to the Internet 110.

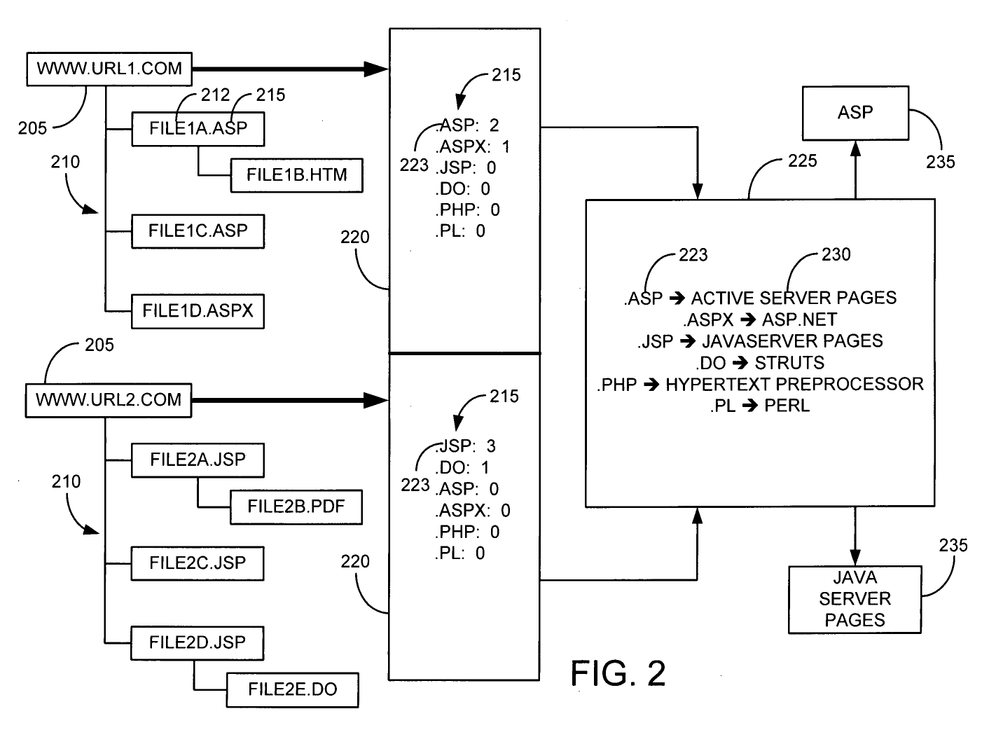

FIG. 2 is a conceptual diagram in accordance with an illustrative embodiment of the invention. In FIG. 2, automated tool 115 has received two root Internet addresses (or Uniform Resource Locators—URLs) 205, www.URL1.com and www.URL2.com, which correspond to two different dynamic Web sites. For example, www.URL1.com and www.URL2.com may point to dynamic Web sites of potential customers who might be interested in purchasing server-side technology solutions for generating dynamic Web content. In general, automated tool 115 may accept one or more root Internet addresses 205 and probe the corresponding dynamic Web sites.

The Web page corresponding to a root Internet address 205 is usually called a “home page.” A home page is a starting point that may contain one or more hyperlinks, each of which points to another Web page. Each of those linked Web pages may, in turn, include additional hyperlinks pointing to still other Web pages, and so forth. In general, a Web page may be static, dynamic, or a combination thereof. Each hyperlink points to a file 210 residing on a server 105. The file name associated with each file 210 includes a root portion 212 and an extension 215 separated by a period (e.g., “asp” in the file name “file1a.asp” is the file extension 215). Those in the computer industry often include the period when specifying file extensions (e.g., “asp”).

Link depth refers to the extent to which a linked Web page is nested relative to a root Internet address 205. Link depth 0 generally refers to the Web page to which the root Internet address 205 itself points (i.e., a home page). Pages linked to a home page are at link depth 1, tertiary Web pages linked in turn to those Web pages are at link depth 2, and so forth. For example, the file 210 “file1a.asp” in FIG. 2 is at link depth 1, and “file1b.htm,” which is linked to file1a.asp, is at link depth 2.

Automated tool 115 may examine a home page at a root Internet address 205 to identify one or more hyperlinks pointing to corresponding files 210. Each hyperlink on the home page may be followed, the hyperlinks on each of those linked Web pages may be identified and followed, and so on, to a predetermined link depth N.

Automated tool 115 may extract the file extension 215 associated with each hyperlinked file 210 and count how many times each distinct file extension 215 occurs among the identified hyperlinks. File extensions 215 generic to rendering technology (e.g., “html” or “pdf”) may optionally be excluded from the analysis since the focus is on dynamic Web content, not static. Automated tool 115 may thus collect and analyze occurrence data 220 for each root Internet address 205, as shown in the simplified example of FIG. 2. In the top portion of FIG. 2, automated tool 115 has counted two occurrences of “.asp” and one occurrence of “.aspx” (note that “.htm” has been excluded from the list). File extension 215 “.aspx” is associated with ASP.NET, a newer version of Microsoft's ASP technology. In the bottom portion of FIG. 2, automated tool 115 has counted three occurrences of “.jsp” (Java Server Pages) and one occurrence of “.do,” which is associated with Struts.

Occurrence data 220 may be analyzed in a variety of ways, including by statistical analysis (e.g., standard deviation). In one embodiment, the various eligible extracted file extensions 215 are ordinally ranked in descending order of the number of occurrences for each, as shown in the example of FIG. 2. Once the occurrence data 220 have been ranked, the file extension 215 having the greatest number of occurrences may, in one embodiment, be designated a “dominant file extension” 223, as shown in FIG. 2. In another embodiment, a file extension 215 is designated as a dominant file extension 223 only if its number of occurrences exceeds, by a predetermined margin, that of the next-highest-ranked file extension 215. For example, a file extension 215 having the greatest number of occurrences may be designated a dominant file extension if its number of occurrences exceeds that of the next-highest-ranked file extension 215 by ten percent. In still other embodiments, multiple dominant file extensions 223 may be designated. For example, in the top portion of FIG. 2, both “.asp” and “.aspx” may be designated as dominant file extensions 223 of the dynamic Web site pointed to by root Internet address www.URL1.com. Those skilled in the Web art will recognize that the presence of both “.asp” and “.aspx” file extensions 215 might indicate a migration from older to newer Microsoft ASP technology at the subject dynamic Web site. Automated tool 115 may be designed to note and point out such patterns.

Once the occurrence data 220 have been collected and analyzed as explained above, automated tool 115 may map each of one or more dominant file extensions 223 to a corresponding server-side technology 230 in accordance with a predetermined mapping scheme 225 (e.g., a lookup table), as illustrated in FIG. 2. Application of mapping scheme 225 yields an inference 235 regarding the server-side technology underlying each subject dynamic Web site. For example, in FIG. 2, automated tool 115 may infer that the dynamic Web site rooted at www.URL1.com is using Microsoft's APS technology. Likewise, automated tool 115 may infer that the dynamic Web site rooted at www.URL2.com is using Java Server Pages to generate its dynamic content.

Automated tool 115 may subsequently report occurrence data 220 and inferences 235 to a user. Such information may be interpreted and used, for example, to generate sales leads, to develop a logical migration path for a given dynamic Web site, or to accomplish other purposes, as explained above.

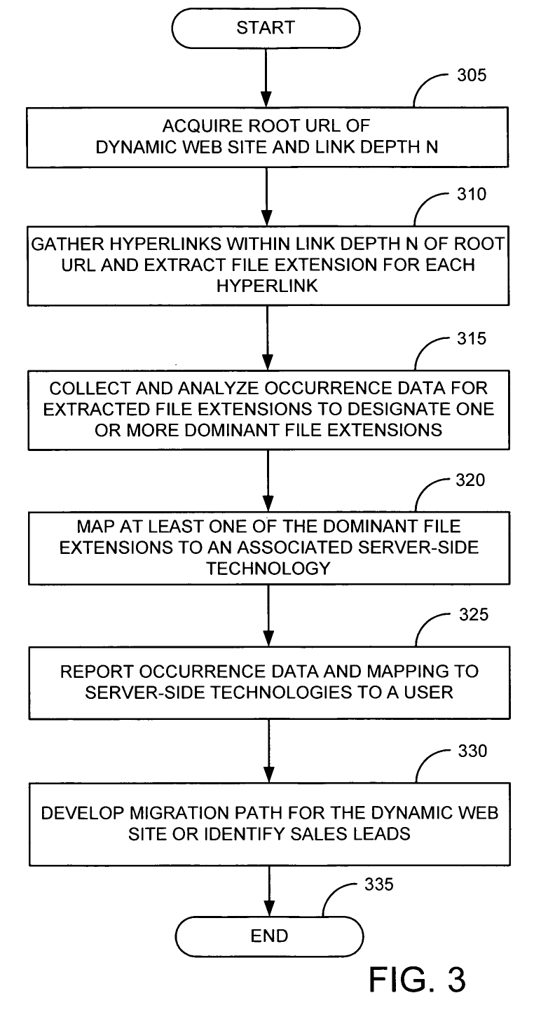

FIG. 3 is a flowchart of a method for automatically determining the server-side technology underlying a dynamic Web site in accordance with an illustrative embodiment of the invention. At 305, automated tool 115 may acquire a root Internet address 205 of a dynamic Web site and a link depth N. At 310, hyperlinks within link depth N of the root Internet address 205 may be identified, and a file extension 215 may be extracted from a file name associated with each hyperlink. At 315, occurrence data 220 for the extracted file extensions 215 may be collected and analyzed to designate one or more dominant file extensions 223. One or more dominant file extensions 223 may be mapped to associated server-side technologies 230 at 320. At 325, occurrence data 220 and any mappings of dominant file extensions 223 to associated technologies 230 may optionally be reported to a user. Further, at 330, automated tool 115 may interpret the reported information to develop a migration path for the subject dynamic Web site, identify sales leads (potential customers), or accomplish some other purpose. The process then terminates at 335.

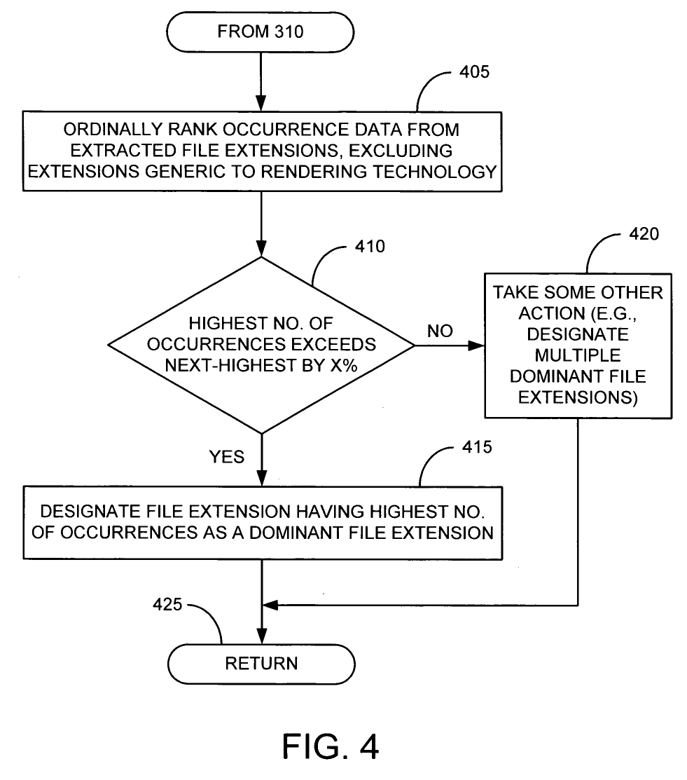

FIG. 4 is a flowchart of a method for collecting and analyzing occurrence data 220 associated with extracted file extensions 215 at step 315 in FIG. 3 in accordance with an illustrative embodiment of the invention. At 405, extracted file extensions 215 may be ranked ordinally according to their respective number of occurrences. As noted above, file extensions 215 generic to rendering technology may be excluded from the analysis of occurrence data 220. At 410, the number of occurrences of the extracted file extension 215 having the greatest number of occurrences may be compared with the number of occurrences of the extracted file extension 215 having the next-highest number of occurrences. If the former exceeds the latter by at least X percent, where X is a predetermined value, the process proceeds to 415, where the extracted file extension 215 having the greatest number of occurrences may be designated as a dominant file extension 223. The test at 410 is just one example of a criterion for designating an extracted file extension 215 as a dominant file extension 223 (i.e., one potentially associated with a predominant server-side technology used by the dynamic Web site). Many variations are possible, including statistical approaches that incorporate, e.g., standard deviation. If the test at 410 fails, automated tool 115 may, at 420, take some other action such as designating multiple dominant file extensions 223, as explained above. At 425, the process may return to, e.g., step 320 in FIG. 3.

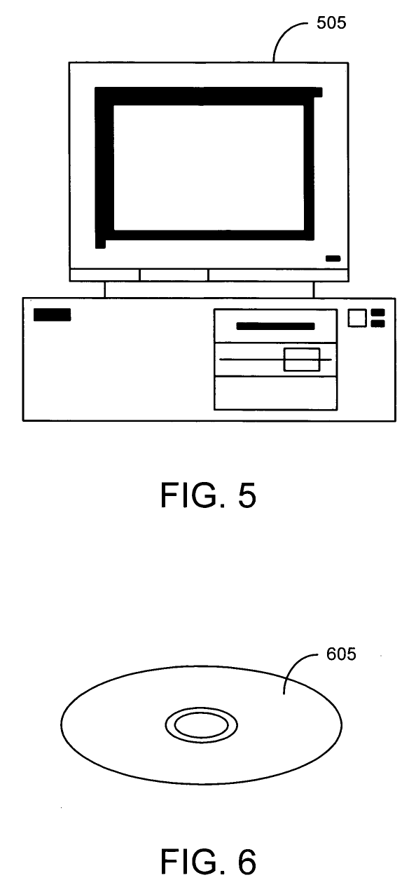

FIG. 5 is an illustration of a system 505 for automatically determining the server-side technology underlying a dynamic Web site in accordance with an illustrative embodiment of the invention. For example, such a system 505 may be programmed to perform the methods shown in FIGS. 3 and 4. Depicted in FIG. 5 is a general-purpose desktop personal computer (PC). However, a server, laptop computer, notebook computer, palmtop computer, personal digital assistant (PDA), or any other suitable computing device may also be used to implement the methods of the invention.

FIG. 6 is an illustration of a computer-readable storage medium 605 containing program code for automatically determining the server-side technology underlying a dynamic Web site in accordance with an illustrative embodiment of the invention. For example, such a computer-readable storage medium 605 may contain stored program instructions implementing the methods shown in FIGS. 3 and 4. FIG. 6 depicts an optical disc (e.g., CD-ROM). However, computer-readable storage medium 605 may be any kind of data storage medium that is readable by a computing device (e.g., system 505), including, but not limited to, a hard disk drive, a floppy diskette, a tape, or a flash memory device.

The foregoing description of the present invention has been presented for the purposes of illustration and description. It is not intended to be exhaustive or to limit the invention to the precise form disclosed, and other modifications and variations may be possible in light of the above teachings. The embodiments were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method for automatically determining the server-side technology underlying a dynamic Web site, comprising:
acquiring a root Internet address of the dynamic Web site and a link depth N comprising a non-negative integer;
identifying hyperlinks on Web pages of the dynamic Web site that are within the link depth N of the root Internet address;
extracting, for each identified hyperlink, a file extension associated with that identified hyperlink;
collecting and analyzing occurrence data associated with the extracted file extensions to designate at least one dominant file extension; and
mapping each of the at least one dominant file extensions to an associated server-side technology.

2. The method of claim 1, wherein extracted file extensions generic to rendering technology are excluded from the analysis of the occurrence data.

3. The method of claim 1, wherein collecting and analyzing occurrence data associated with the extracted file extensions comprises ordinally ranking the extracted file extensions according to a number of occurrences for each extracted file extension and wherein the extracted file extension having the greatest number of occurrences is designated as a dominant file extension.

4. The method of claim 3, wherein the number of occurrences of the extracted file extension having the greatest number of occurrences exceeds, by a predetermined margin, the number of occurrences of the extracted file extension having the next-highest number of occurrences.

5. The method of claim 1, further comprising:
reporting the occurrence data and the mapping of dominant file extensions to associated server-side technologies to a user.

6. The method of claim 5, further comprising:
interpreting the reported occurrence data and mapping of dominant file extensions to associated server-side technologies to determine an advantageous server-side technology migration path for the dynamic Web site.

7. The method of claim 5, further comprising:
interpreting the reported occurrence data and mapping of dominant file extensions to associated server-side technologies to determine whether an entity associated with the dynamic Web site is a potential customer.

8. A system programmed to perform the following method:
(a) acquiring a root uniform resource locator of a dynamic Web site and a link depth N comprising a non-negative integer;
(b) identifying hyperlinks on Web pages of the dynamic Web site that are within the link depth N of the root uniform resource locator;
(c) extracting, for each identified hyperlink, a file extension associated with that identified hyperlink;
(d) collecting and analyzing occurrence data associated with the extracted file extensions to designate at least one dominant file extension; and
(e) mapping each of the at least one dominant file extensions to an associated server-side technology to infer automatically the server-side technology underlying the dynamic Web site.

9. The system of claim 8, wherein, in step (d) of the method, extracted file extensions that are generic to rendering technology are excluded from the analysis of the occurrence data.

10. The system of claim 8, wherein step (d) of the method comprises ordinally ranking the extracted file extensions according to a number of occurrences for each extracted file extension and designating as a dominant file extension the extracted file extension having the greatest number of occurrences.

11. The system of claim 10, wherein the number of occurrences of the extracted file extension having the greatest number of occurrences exceeds, by a predetermined margin, the number of occurrences of the extracted file extension having the next-highest number of occurrences.

12. The system of claim 8, wherein the method comprises the following additional step:
reporting the occurrence data and the mapping of dominant file extensions to associated server-side technologies to a user.

13. The system of claim 12, wherein the method comprises the following additional step:
interpreting the reported occurrence data and mapping of dominant file extensions to associated server-side technologies to determine an advantageous server-side technology migration path for the dynamic Web site.

14. The system of claim 12, wherein the method comprises the following additional step:
interpreting the reported occurrence data and mapping of dominant file extensions to associated server-side technologies to determine whether an entity associated with the dynamic Web site is a potential customer.

15. A system for automatically determining the server-side technology underlying a dynamic Web site, comprising:
means for acquiring a root Internet address of the dynamic Web site and a link depth N comprising a non-negative integer;
means for identifying hyperlinks on Web pages of the dynamic Web site that are within the link depth N of the root Internet address;
means for extracting, for each identified hyperlink, a file extension associated with that identified hyperlink;
means for collecting and analyzing occurrence data associated with the extracted file extensions to designate at least one dominant file extension; and
means for mapping each of the at least one dominant file extensions to an associated server-side technology.

16. The system of claim 15, further comprising:
means for reporting the occurrence data and the mapping of dominant file extensions to associated server-side technologies to a user.

17. The system of claim 16, further comprising:
means for interpreting the reported occurrence data and mapping of dominant file extensions to associated server-side technologies to determine an advantageous server-side technology migration path for the dynamic Web site.

18. The system of claim 16, further comprising:
means for interpreting the reported occurrence data and mapping of dominant file extensions to associated server-side technologies to determine whether an entity associated with the dynamic Web site is a potential customer.

19. A computer-readable storage medium containing program code for automatically determining the server-side technology underlying a dynamic Web site, comprising:
a first code segment that acquires a root uniform resource locator of the dynamic Web site and a link depth N comprising a non-negative integer;
a second code segment that identifies hyperlinks on Web pages of the dynamic Web site that are within the link depth N of the root uniform resource locator;
a third code segment that extracts, for each identified hyperlink, a file extension associated with that identified hyperlink;
a fourth code segment that collects and analyzes occurrence data associated with the extracted file extensions to designate at least one dominant file extension; and
a fifth code segment that maps each of the at least one dominant file extensions to an associated server-side technology.

20. The computer-readable storage medium of claim 19, further comprising:
a sixth code segment that reports the occurrence data and the mapping of dominant file extensions to associated server-side technologies to a user.
